(19) United States
(12) Patent Application Publication
(10) Pub. No.: US 2007/0038952 A1
(43) Pub. Date: Feb. 15, 2007

(54) Mobile communication terminal

(76) Inventors: Erika Reponen, Tampere (FI); Virpi Roto, Espoo (FI); Elina Vartiainen, Helsinki (FI); Mika Rautava, Espoo (FI)

Correspondence Address: PERMAN & GREEN, 425 POST ROAD, FAIRFIELD, CT, 06824, US

(21) Appl. No.: 11/444,863

(22) Filed: Jun. 1, 2006

Related U.S. Application Data
(63) Continuation-in-part of application No. 11/170,794, filed on Jun. 29, 2005.

(51) Int. Cl. G06F 17/00

(52) U.S. Cl. 715/783

(57) ABSTRACT

Controlling displaying of a plurality of pages in a browser application for execution in a mobile communication terminal including a display. A first set of graphical representations of pages previously displayed in a first browser window is created. If a second browser window exists, creating a second set of graphical representations of pages previously displayed in a second browser window. At least a subset of the first set is displayed in a first spatial sequence along a first direction of the display. If a second browser window exists, displaying at least a subset of the second set in a second spatial sequence along the first direction and separated from the first spatial sequence a distance along a second direction perpendicular to the first direction. An indicator is shown on the display that indicates a most recently visited page.

### CROSS-REFERENCE TO RELATED APPLICATIONS

This application is a Continuation-in-part application of U.S. patent application Ser. No. 11/170,794, filed on Jun. 29, 2005, status pending.

### FIELD

The disclosed embodiments relate generally to browser applications of mobile communication terminals, and more particularly to displaying pages in browsers of mobile communication terminals.

### BACKGROUND

Mobile communication terminals have changed dramatically in the last decade. With the first 2G terminals, the only real purpose was to make normal phone calls. Now with 2.5G (GPRS), CDMA2000 and UMTS technology, mobile communication terminals not only facilitate voice communication, but also digital communication such as text and multimedia messaging, as well as browsing content provided by Internet servers.

A function usually present in browser applications is the ability to navigate to previously visited pages, also known as history items. One way of doing this is to use a back button of the browser to go backward in history, and a forward button to go forward in history. Often a history mode can be triggered, where history items for the current window are displayed in a list, allowing a user to select a history item in the list.

For browsers in mobile communication terminals, it is even more pressing to provide the user friendly history function, as using the back and forward buttons often cause a noticeable delay due to a limitation of resources in mobile communication terminals.

US patent application US2004/0003351 presents a browser session navigation tool allowing a user to browse graphically represented previously viewed resource pages.

US patent application US2004/0139143 presents a web navigation scheme that allows for a multi-dimensional navigation.

There still remains a problem of how to present the user with a intuitive and simple user interface to navigate among history items.

### SUMMARY

In view of the above, an objective of the invention is to solve or at least reduce the above-identified and other problems and shortcomings with the prior art, and to provide improvements to a mobile communication terminal.

Generally, the above objectives and purposes are achieved by methods, mobile communication terminals and computer program products according to the attached independent patent claims.

A first aspect of the invention is a method for controlling displaying of a plurality of pages in a browser application for execution in a mobile communication terminal comprising a display. Said method comprises the steps of:

creating a first set of graphical representations of pages previously displayed in a first browser window,

if a second browser window exists, creating a second set of graphical representations of pages previously displayed in a second browser window,

displaying at least a subset of said first set in a first spatial sequence along a first direction of said display,

if a second browser window exists, displaying at least a subset of said second set in a second spatial sequence along said first direction and separated from said first spatial sequence a distance along a second direction perpendicular to said first direction, and

displaying an indicator on said display, said indicator indicating a most recently visited page.

This method provides a way for the user to navigate among representations relating to a plurality of windows, each window having a plurality of representations, from a single screen.

In said step of displaying an indicator, if a graphical representation corresponding to said most recently visited page is available on said display, said indicator may be displayed at a location associated with said graphical representation corresponding to said most recently visited page. Available in this context should be construed as at least partly displayed on said display.

In said step of displaying an indicator, if a graphical representation corresponding to said most recently visited page is unavailable on said display, said indicator may be located to indicate a logical direction of said graphical representation corresponding to said most recently visited page. Unavailable in this context should be construed as displayed in a different way from when said graphical representation is available. For example, an unavailable representation may be not displayed at all, displayed in a different color, size or contrast, to indicate that

In said step of displaying an indicator, said indicator may be rendered to resemble a pin.

Said first and second spatial sequences may correspond to a respective time sequence in which said respective pages have been displayed.

Said graphical representations may comprise miniature representations of previously displayed pages.

Said graphical representations may comprise at least partial miniature representations of previously displayed pages.

Said graphical representations may comprise graphical symbols representing previously displayed pages.

In an embodiment, said first direction may be horizontal and said second direction may be vertical.

In an embodiment, said first direction may be vertical and said second direction may be horizontal.

The method may further comprise the step of:

detecting a first user action indicating a desire to select a preferred representation, and

highlighting said preferred representation.

The method may further comprise the step of:

detecting a second user action indicating a desire to display a page corresponding to said preferred representation, and

displaying said page.

Said step of detecting a first user action may comprise detection via an input device, said input device being a device selected from the group comprising a navigation key, a joystick, a key on a keypad, a key dedicated for this purpose and a voice command means.

Said step of detecting a second user action may comprise detection via an input device, said input device being a device selected from the group comprising a navigation key, a joystick, a key on a keypad, a key dedicated for this purpose and a voice command means.

Said step of displaying said page may comprise retrieving said page from a server via a digital network.

Said step of displaying said page may comprise retrieving said page from a memory in said mobile communication terminal.

Said step of highlighting said preferred representation may comprise centering said preferred representation on said display.

Said step of highlighting said preferred representation may comprise increasing the size of said preferred representation.

Said step of highlighting said preferred representation comprise displaying a frame around said representation.

Said step of highlighting said preferred representation may comprise enhancing a contrast of said preferred representation.

Said step of highlighting said preferred representation may comprise color enhancing said preferred representation.

Said step of highlighting said preferred representation may comprise displaying a text in a proximity to said preferred representation.

A second aspect of the invention is a mobile communication terminal comprising a display, said mobile communication terminal being configured to display a plurality of pages in a browser application for execution in said mobile communication terminal. The mobile communication terminal comprises:

means for creating a first set of graphical representations of pages previously displayed in a first browser window,

means for, if a second browser window exists, creating a second set of graphical representations of pages previously displayed in a second browser window,

means for displaying at least a subset of said first set in a first spatial sequence along a first direction of said display,

means for, if a second browser window exists, displaying at least a subset of said second set in a second spatial sequence along said first direction and separated from said first spatial sequence a distance along a second direction perpendicular to said first direction, and

means for displaying an indicator on said display, said indicator indicating a most recently visited page.

This method provides a mobile communication terminal allowing the user to navigate among representations relating to a plurality of windows, each window having a plurality of representations, from a single display.

A third aspect of the invention is a computer program product comprising software instructions that, when executed in a mobile communication terminal, performs a method of the first aspect of the invention.

This computer program product provides a way for the user to navigate among representations relating to a plurality of windows, each window having a plurality of representations, from a single display.

Other objectives, features and advantages of the present invention will appear from the following detailed disclosure, from the attached dependent claims as well as from the drawings.

### BRIEF DESCRIPTION OF THE DRAWINGS

The present invention will now be described in more detail, reference being made to the enclosed drawings.

FIG. 1 is a schematic block diagram of a mobile telecommunication terminal and related entities according to an embodiment of the present invention.

FIG. 2 is a schematic diagram showing a mobile communication terminal and some of its external components according to an embodiment of the present invention.

FIG. 3 is a schematic block diagram showing the internal component and software structure of a mobile terminal according to an embodiment of the present invention.

FIG. 4 is a flowchart illustrating a method in an embodiment of the present invention to display pages.

FIGS. 5A-E show a number of ways of how to highlight a particular representation in an embodiment of the present invention.

FIGS. 6A-C show different usage scenarios for a last visited page indication in an embodiment of the invention.

### DETAILED DESCRIPTION OF THE INVENTION

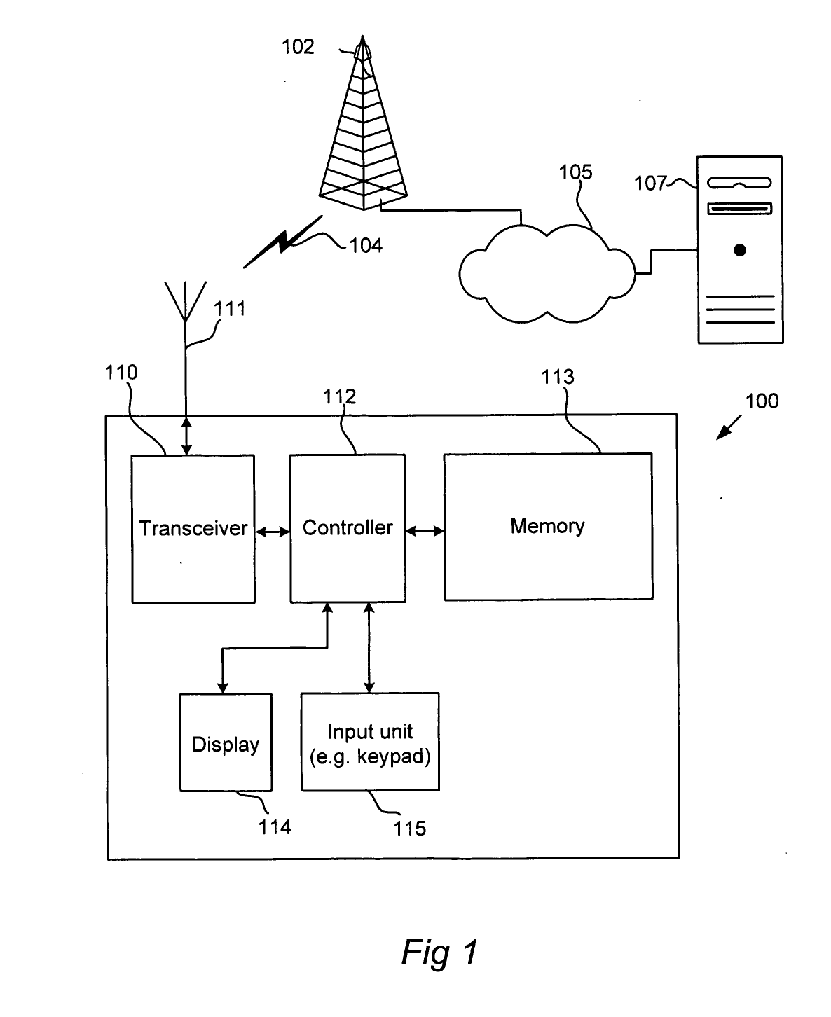

FIG. 1 is a schematic block diagram of a mobile telecommunication terminal 100 and related entities according to an embodiment of the present invention. A transceiver 110 is used for communicating with a base station 102 via an antenna 111. The base station 102 is in communication, either directly or indirectly via other entities not shown in the diagram, with other networks such as a digital network 105. The digital network 105 may for example be a wide area network (WAN) such as the Internet or a local area network (LAN). Also connected to the digital network 105 is a server 107. The server 107 may be any type of computing device with computational ability and capability to connect to the digital network 105. This includes servers running any of a multitude of operating systems, for example, UNIX-related operating systems, Linux, BSD, Sun Solaris, Microsoft Windows, Mac OS X, Novell Netware, etc. The transceiver 110 may be arranged to operate in accordance with any appropriate telecommunications standard, such as GSM, UMTS, CDMA2000, W-CDMA, EDGE, IEEE802.11, etc.

The mobile terminal has a controller 112 which is responsible for the overall operation of the mobile terminal and is preferably implemented by any commercially available CPU (“Central Processing Unit”), DSP (“Digital Signal Processor”) or any other electronic programmable logic device such as a microcontroller. The controller 112 has associated electronic memory 113 such as RAM memory, ROM memory, EEPROM memory, flash memory, or any combination thereof. The memory 113 is used for various purposes by the controller 112, one of them being for storing data and program instructions for various software in the mobile terminal.

The controller 112 is coupled to a display 114 for providing a user of the mobile telecommunication terminal 100 with visual data regarding e.g. a specific call in progress, telecommunication numbers stored in the mobile telecommunication terminal 100, signal strength of the wireless communication link 104, messages received from other mobile telecommunication terminals, etc. In particular, the display may provide the user of the mobile telecommunication terminal 100 with text and graphics data from a web/wap page.

The controller 112 is moreover coupled to an input unit 115, which may be in the form of a keyboard/keypad, an on-screen touch-sensitive keyboard, a navigation wheel or joystick for scrolling and selecting items, digits and/or characters shown on the display 112, etc. The input unit 115 may be integral with the mobile telecommunication terminal 100 or separate from the mobile telecommunication terminal 100, wherein the input unit is connected to the mobile telecommunication terminal when needed. The mobile telecommunication terminal 100 may alternatively be provided with an integral input unit 115 in the form of a small size keyboard, such as a 12-key numeric keypad (digits 0-9, * and #), for normal use as well as a connector for connecting an external input unit e.g. in the form of a QWERTY keyboard for entering larger amounts of text (not shown).

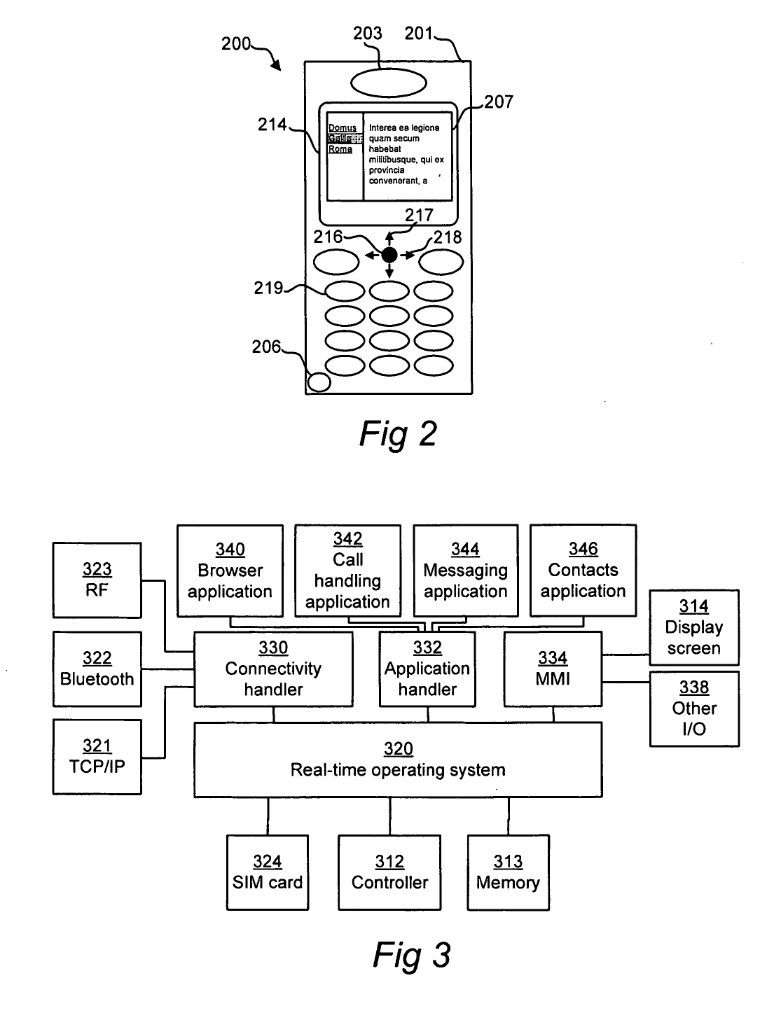

An embodiment 200 of the mobile terminal 100 is illustrated in FIG. 2. As is well known in the art, the mobile terminal 200 comprises an apparatus housing 201, a loudspeaker 203, a display 214, a set of keys 219 which may include a keypad of common ITU-T type (alpha-numerical keypad), and a microphone 206. In addition, but not shown in FIG. 2, the mobile terminal 200 comprises various internal components, the more important of which are illustrated in FIG. 1. The external components 203, 214, 219 and 206 are all part of the user interface of the mobile terminal.

Furthermore, the user interface involves a multi-way input device 216 in the form of a joystick, the handle of which may be actuated by the user in a plurality of directions 217/218 so as to command navigating operations, i.e. to navigate in corresponding directions among information 207 shown on display 214, in a manner which is conventional per se for joystick-equipped mobile terminals. The navigation directions may be four in number, as indicated by solid arrows 217 in FIG. 2a, and may be distributed orthogonally in an “up, down, left, right” fashion with respect to a base plane which is essentially coincidental or parallel with the display 214 and the front surface of apparatus housing 201. Alternatively, navigation directions may be increased to 8, with additional intermediate directions being provided between the four directions mentioned above. The user may also perform a selecting operation among information 207 by actuating the joystick 216 in a direction perpendicular to the base plane, e.g. by depressing the joystick at its top. Depending on implementation, this will either cause displacement of the entire joystick handle, or will cause depression of a joystick select button. In some embodiments such a joystick select button may be located at the top of the joystick handle; in others it may be mounted next to the joystick handle on the base plane. It is to be noted that a four-way, five-way, eight-way or nine-way navigation key may be used to provide the same functionality as provided by a joystick.

The internal component and software structure of a mobile terminal according to one embodiment will now be described with reference to FIG. 3. The mobile terminal has a controller 312, corresponding to the controller 112 of FIG. 1. The controller 312 has associated electronic memory 313 corresponding to the memory 113 of FIG. 1. The memory 313 is used for various purposes by the controller 312, one of them being for storing data and program instructions for various software in the mobile terminal. The software includes a real-time operating system 320, man-machine interface (MMI) drivers 334, an application handler 332 as well as various applications 340, 342, 344 and 346. A particular application is a browser application 340. The browser application may display wap and/or web pages from servers on operator specific servers or servers on the Internet. The browser application uses a TCP/IP stack contained in a connectivity handler 330 to communicate with servers via an RF module 323 or a Bluetooth module 322. To minimize the amount of data that needs to be transferred, the browser application 340 may store recently viewed pages in the memory 313. Consequently, if a user requests to view a recently viewed page, it may be retrieved from the memory 313 instead of again retrieving the page over the network or Bluetooth™. Other applications may include a call handling application 342, a messaging application 344 and a contacts application 346. As known in the art, several other applications may be included (not shown) including, but not limited to, a calendar application, a control panel application, a camera application, a media player, a video game, a notepad application, etc.

The MMI drivers 334 cooperate with the display 314 as well as various other I/O devices 338 such as a microphone, a speaker, a vibrator, a keypad, a joystick, a ringtone generator, an LED indicator, volume controls, etc. As is commonly known, a user may operate the mobile terminal through the man-machine interface thus formed.

The software also includes various modules, protocol stacks, drivers, etc., which are commonly designated as a connectivity handler 330 and which provide communication services (such as transport, network and connectivity) for an RF interface 323, and optionally the Bluetooth interface 322, a WLAN interface (not shown), or an IrDA interface (not shown). The RF interface 323 comprises an internal or external antenna as well as appropriate radio circuitry for establishing and maintaining a wireless link to a base station (e.g. the link 104 and base station 102 in FIG. 1). As is well known to a man skilled in the art, the radio circuitry comprises a series of analog and digital electronic components, together forming a radio receiver and transmitter. These components include, inter alia, band pass filters, amplifiers, mixers, local oscillators, low pass filters, AD/DA converters, etc.

The mobile terminal may also have a SIM card 324 and an associated reader. As is commonly known, the SIM card 324 comprises a processor as well as local work and data memory.

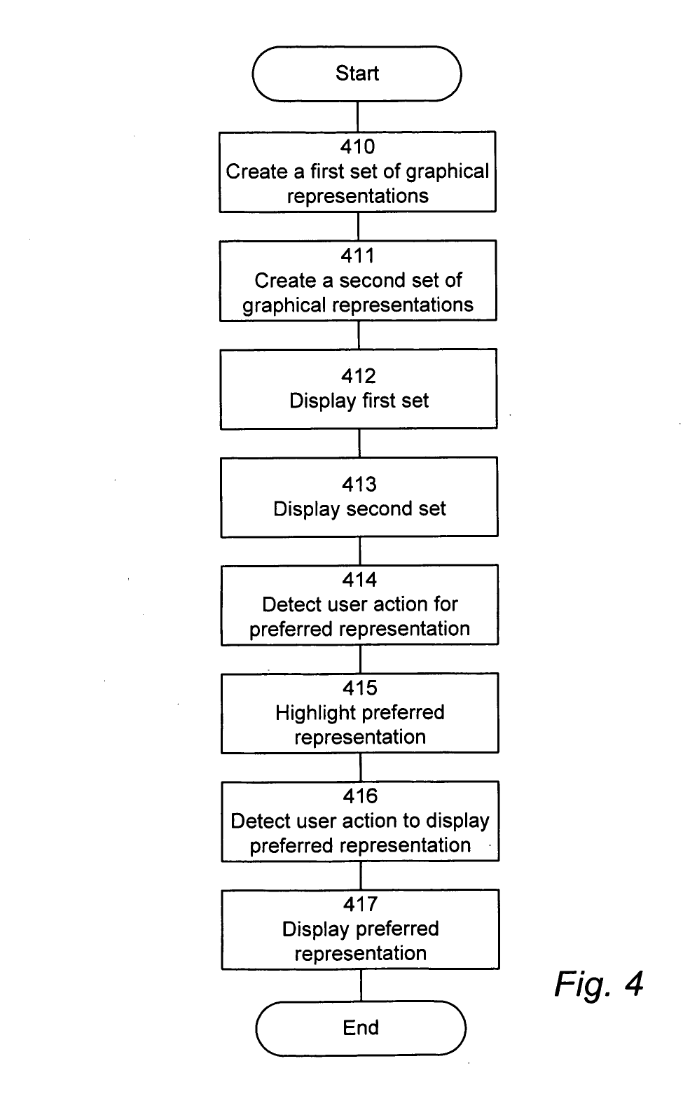

FIG. 4 is a flowchart illustrating a method in an embodiment of the present invention to display pages. In this embodiment, the pages may for example be www history pages or wap history pages, but may be any other type of page with content that may be displayed on a graphical display. In one embodiment, the method is executed in a history mode, triggered by an input from the user, such as a depression of a dedicated key, a depression of a key temporarily assigned to receive this input (also known as a soft key), depression of a combination of keys, an input via the joystick, a voice command, or any other appropriate input method. Alternatively, in a single mode embodiment, the ability to select history items as described below is always present, whereby no start trigger from the user is required.

In a create a first set of graphical representations step 410, a number of graphical representations of previously visited web pages of a first browser window are created. This is similar to a history list in that each representation corresponds to a previously visited page. The graphical representations are preferably, but not necessarily, miniatures, also known as thumbnails, of the visited web pages. The miniature representations may be miniatures of the entire page or miniatures of a subset of the page. If the miniature is a subset, the subset may be positioned in the top left corner, at a position corresponding to how the page was last displayed, or at a position which is particularly representable for the page. Optionally, the representation may be a symbol, for example an icon, representing the page. The set of graphical representations that are created may be the complete set of previously visited pages in the first browser window, or it may be a subset, such as the one last, 10 last or any preferred number of last visited pages. If the need later arises, another subset may then be prepared.

In a create a second set of graphical representations step 411, a second set of graphical representations are created analogously to the first set of graphical representations, but relating to a second browser window. The second set may be the complete set of previously visited pages in the second browser window, or it may be a subset, such as the one last, 10 last or any preferred number of last visited pages. In other words, the browser has at least two windows active, whereby the first set of representations relate to a current window and the second set of representations relate to a second, inactive window. Additional sets may be created, where each set corresponds to previously viewed pages in a distinct window. The functionality of a second window may also be realized by having a second, separate browsing thread, with its own history. Optionally, if no second window or browsing thread exists, the second set may be empty.

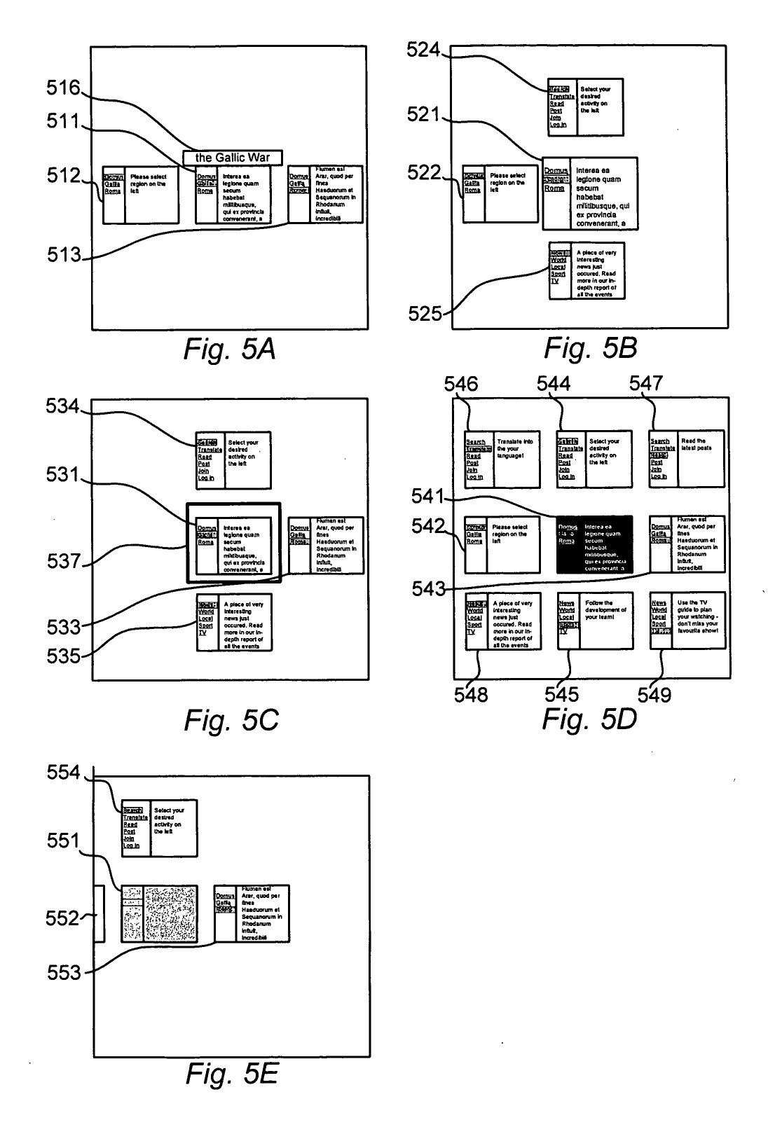

In a display first set step 412, the first set of representations is displayed on the display 204 of the mobile communication terminal 200. The representations are presented in a line, preferably horizontally or vertically. If the first set contains more representations than can fit in the display 204, a subset of the representations is displayed. Preferably, the latest viewed page is initially selected through highlighting explained in more detail in conjunction with FIG. 5 below.

In a display second set step 413, all or a subset of the second set is displayed on the display 204 on the mobile communication terminal 200. The second set is displayed in a line parallel to the line for the first set. In an embodiment, the subset of the second set may contain only one item, to conserve processing power and memory usage. If the subset only contains one representation, the representation is not presented in a line as such, but the one representation of the subset will still be displayed a perpendicular distance from the line of the first subset. If additional sets are present, these sets are displayed accordingly. The sets may be sorted in an order of when the corresponding windows were initially opened, in an order of when the windows were last visited, or any other suitable order. This sorting is particularly applicable when there are more than two sets available. Optionally, if the second set, third set, etc. are empty, this step does not display any representations.

During the display of the sets, a virtual display may be used such that items outside the area visible in the display are partially or fully hidden, whereby the user can view these by using scrollbars, zooming or other screen navigation functions.

In a detect user action for preferred representation step 414, it is detected what representation a user prefers. The user may have navigated through available representations using a joystick 216 or by means of a touch sensitive screen, a menu system, voice recognition or any other suitable input method. A user may navigate to representations backward and forward in history for any window represented on the display 204.

In a highlight preferred representation step 415, the preferred representation is highlighted, such as is described in conjunction with FIG. 5 below. The detect user action for preferred representation step 414 and the highlight preferred representation step 415 may be repeated until the user is satisfied. In the single mode method alternative, the highlighting of the preferred representation is enough to allow the user to view the content of the displayed page. For example, the highlighting may be to enlarge the preferred view and to place the preferred view in the center of the display, allowing the user to view the preferred representation. In the single mode alternative, the highlighted representation thus performs like a regular browser window, allowing the user to scroll within the window, activate links, etc.

In a detect user action to display preferred representation step 416, the user indicates that he/she would like to view the page corresponding to the currently preferred representation. This may be detected, for example, by a depression of a dedicated key, a depression of a key temporarily assigned to receive this input (also known as a soft key), depression of a combination of keys, an input via the joystick, a voice command, or any other appropriate input method. Alternatively, a timeout may trigger the display of the preferred representation, where the timeout is a period of time when no user input is provided. In the single mode method alternative, this step is superfluous, as the preferred representation is already in full view for the user.

In a display preferred representation step 417, the main browser window takes control of the screen again and the preferred page is displayed in the display 204. The page may be retrieved from a server 107 through the network 105, depicted in FIG. 1. To reduce loading time and network traffic, the page may alternatively be retrieved as a previously stored copy from the memory 113, a method which is also known as caching. In the single mode method alternative, this step is superfluous, as the preferred representation is already in full view for the user.

FIGS. 5A-E show several alternative ways of how to highlight a particular representation. This is useful for instance when the user wishes to select a particular representation to display. Note that the different highlighting options may be combined in any way preferred.

In FIG. 5A, representation 511 is a highlighted representation of a page displayed in the first browser window, representation 512 is a representation of a page previously viewed in the first browser window at a point in time before the page of the highlighted representation 511 and representation 513 is a representation of a page previously viewed in the first browser window at a point in time after the page of the highlighted representation 511.

In FIG. 5A, the highlighted representation 511 is indicated by positioning the highlighted representation 511 in the center. Additionally, a text 511 related to the page of the highlighted representation, for example a title text, is displayed.

In FIG. 5B, representation 521 is a highlighted representation of a page displayed in the first browser window, representation 522 is a representation of a page previously viewed in the first browser window at a point in time before the page of the highlighted representation 521. Note that in this case there is no representation to the right of the highlighted representation 521. This is due to there being no page having been displayed a point in time after the page of the highlighted representation 521 in the first window. In other words, there is no forward history from the highlighted representation 521. Representation 524 is a representation of a page of a second browser window and Representation 525 is a representation of a page of a third browser window.

In FIG. 5B, the highlighted representation 521 is indicated by increasing the size of the highlighted representation 521 compared to other representations.

In FIG. 5C, representation 531 is a highlighted representation of a page displayed in the first browser window, and representation 533 is a representation of a page previously viewed in the first browser window at a point in time after the page of the highlighted representation. Note that in this case there is no representation to the left of the highlighted representation 531. This is due to there being no page having been displayed a point in time before the page of the highlighted representation 531 in the first window. In other words, there is no backward history from the highlighted representation 531. Representation 534 is a representation of a page of a second browser window and Representation 535 is a representation of a page of a third browser window.

In FIG. 5C, the highlighted representation 531 is indicated by displaying a frame 537 around the highlighted representation 531 in the center.

In FIG. 5D, representation 541 is a highlighted representation of a page displayed in the first browser window, representation 542 is a representation of a page previously viewed in the first browser window at a point in time before page of the highlighted representation 541 and representation 543 is a representation of a page previously viewed in the first browser window at a point in time after page of the highlighted representation 541. Representations 546, 544 and 547 are all representations of pages previously viewed in a second window, where these pages were viewed in a time order corresponding to the positions of 546, 544 and 547. In other words, the page of representation 546 was displayed before the page of representation 544 which in turn was displayed before the page of representation 547. Representations 548, 545 and 549 are all representations of pages previously viewed in a third window, where these pages were viewed in a corresponding time order of 546, 544 and 547.

In FIG. 5D, the highlighted representation 541 is indicated by enhancing the contrast of the highlighted representation 541.

In FIG. 5E, representation 551 is a highlighted representation of a page displayed in the first browser window, representation 552 is a representation of a page previously viewed in the first browser window at a point in time before the page of the highlighted representation 551 and representation 553 is a representation of a page previously viewed in the first browser window at a point in time after the page of the highlighted representation 551. Note that the representation 552 is only partially visible in this example. Representation 554 is a representation of a page of a second browser window.

In FIG. 5E, the highlighted representation 551 is indicated by enhancing the color of the highlighted representation 551.

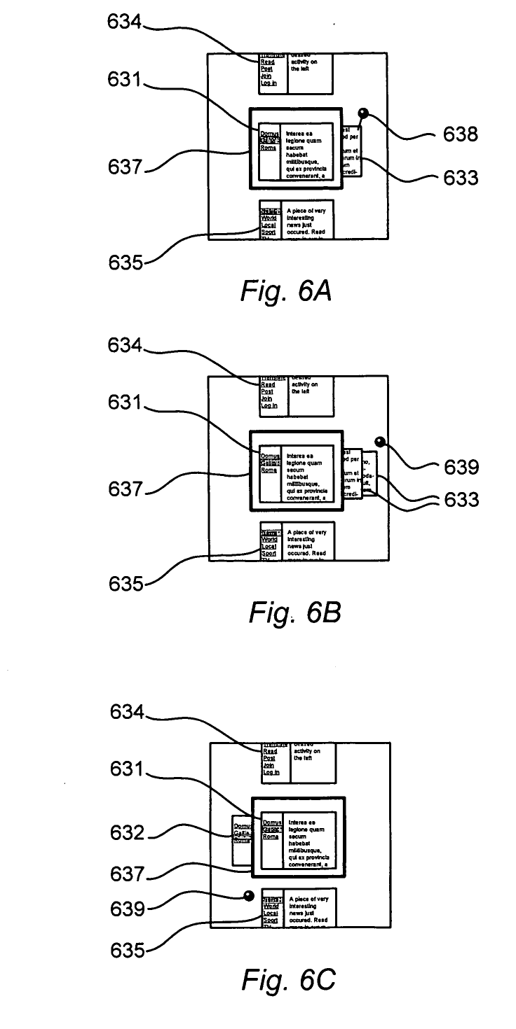

FIGS. 6A-C show different usage scenarios for a last visited page indicator in the mobile terminal 200 shown in FIG. 2. The structure of the screen is similar to what is shown in FIGS. 5A-E.

In FIG. 6A, representation 631 is a highlighted representation of a page displayed in a first browser window, and representation/representations 633 are representations of pages previously viewed in the first browser window at a point in time after the page of the highlighted representation 631. Note that in FIG. 6A there is no representation to the left of the highlighted representation 631. This is due to there being no page having been displayed a point in time before the page of the highlighted representation 631 in the first window. In other words, there is no backward history from the highlighted representation 631. Representation 634 is a representation of a page of a second browser window and Representation 635 is a representation of a page of a third browser window.

A last visited page indicator 638 indicates what page was last visited before the history view was displayed. In this example the indicator 638 is displayed as a pin, but any suitable graphic implementation can be chosen.

The indicator 638 reduces the risk that the user gets lost in the history navigation screen. The user can thus easily see on which page on which window he/she was before navigating to history navigation screen.

FIG. 6B illustrates a situation in which the user has navigated so far back in history that the representation for the last visited page is no longer visible on the screen. A last visited page indicator 639 is located in the direction where the page is located but accordingly not connected to any representation. In the case that the indicator 639 is a pin, only the head of the pin is shown, implying that the indicator 639 is not connected to a representation.

In FIG. 6C, representation 632 is a representation of a page previously viewed in the first browser window at a point in time before the page of the highlighted representation 631. Furthermore, in this figure, the last visited page is a page back in history before the representation 635 of the page in the third browser window. Consequently, the last visited page indicator 639 shows the direction where the last visited page is located in this third browser window.

The invention has mainly been described above with reference to a number of embodiments. However, as is readily appreciated by a person skilled in the art, other embodiments than the ones disclosed above are equally possible within the scope of the invention, as defined by the appended patent claims.

What is claimed is:

1. A method for controlling displaying of a plurality of pages in a browser application for execution in a mobile communication terminal comprising a display, said method comprising:
creating a first set of graphical representations of pages previously displayed in a first browser window,
if a second browser window exists, creating a second set of graphical representations of pages previously displayed in a second browser window,
displaying at least a subset of said first set in a first spatial sequence along a first direction of said display,
if a second browser window exists, displaying at least a subset of said second set in a second spatial sequence along said first direction and separated from said first spatial sequence a distance along a second direction perpendicular to said first direction, and
displaying an indicator on said display, said indicator indicating a most recently visited page.

2. The method of claim 1, wherein in displaying an indicator, if a graphical representation corresponding to said most recently visited page is available on said display, said indicator is displayed at a location associated with said graphical representation corresponding to said most recently visited page.

3. The method of claim 1, wherein in displaying an indicator, if a graphical representation corresponding to said most recently visited page is unavailable on said display, said indicator is located to indicate a logical direction of said graphical representation corresponding to said most recently visited page.

4. The method of claim 1, wherein in displaying an indicator, said indicator is rendered to resemble a pin.

5. The method of claim 1, wherein said first and second spatial sequences correspond to a respective time sequence in which said respective pages have been displayed.

6. The method of claim 1, wherein said graphical representations comprise miniature representations of previously displayed pages.

7. The method of claim 1, wherein said graphical representations comprise at least partial miniature representations of previously displayed pages.

8. The method of claim 1, wherein said graphical representations comprise graphical symbols representing previously displayed pages.

9. The method of claim 1, wherein said first direction is horizontal and said second direction is vertical.

10. The method of claim 1, wherein said first direction is vertical and said second direction is horizontal.

11. The method of claim 1, further comprising:
detecting a first user action indicating a desire to select a preferred representation, and
highlighting said preferred representation.

12. The method of claim 11, further comprising:
detecting a second user action indicating a desire to display a page corresponding to said preferred representation, and
displaying said page.

13. The method of claim 11, wherein said detecting a first user action comprises detection via an input device, said input device being a device selected from the group comprising a navigation key, a joystick, a key on a keypad, a key dedicated for this purpose and a voice command means.

14. The method of claim 12, wherein said detecting a second user action comprises detection via an input device, said input device being a device selected from the group comprising a navigation key, a joystick, a key on a keypad, a key dedicated for this purpose and a voice command means.

15. The method of claim 12, wherein said displaying said page comprises retrieving said page from a server via a digital network.

16. The method of claim 12, wherein said displaying said page comprises retrieving said page from a memory in said mobile communication terminal.

17. The method of claim 11, wherein said highlighting said preferred representation comprises centering said preferred representation on said display.

18. The method of claim 11, wherein said step of highlighting said preferred representation comprises increasing the size of said preferred representation.

19. The method of claim 11, wherein said highlighting said preferred representation comprises displaying a frame around said representation.

20. The method of claim 11, wherein said highlighting said preferred representation comprises enhancing a contrast of said preferred representation.

21. The method of claim 11, wherein said highlighting said preferred representation comprises color enhancing said preferred representation.

22. The method of claim 11, wherein said highlighting said preferred representation comprises displaying a text in a proximity to said preferred representation.

23. A mobile communication terminal comprising a display, said mobile communication terminal being configured to display a plurality of pages in a browser application for execution in said mobile communication terminal, said mobile communication terminal furthermore comprising:
means for creating a first set of graphical representations of pages previously displayed in a first browser window,
means for, if a second browser window exists, creating a second set of graphical representations of pages previously displayed in a second browser window,
means for displaying at least a subset of said first set in a first spatial sequence along a first direction of said display,
means for, if a second browser window exists, displaying at least a subset of said second set in a second spatial sequence along said first direction and separated from said first spatial sequence a distance along a second direction perpendicular to said first direction, and
means for displaying an indicator on said display, said indicator indicating a most recently visited page.

24. A mobile communication terminal comprising a display and a controller, wherein:
said mobile communication terminal is configured to display a plurality of pages in a browser application for execution in said mobile communication terminal,
said controller is configured to create a first set of graphical representations of pages previously displayed in a first browser window,
said controller is configured to, if a second browser window exists, create a second set of graphical representations of pages previously displayed in a second browser window,
said controller is configured to display at least a subset of said first set in a first spatial sequence along a first direction of said display,
said controller is configured to, if a second browser window exists, display at least a subset of said second set in a second spatial sequence along said first direction and separated from said first spatial sequence a distance along a second direction perpendicular to said first direction, and
said controller is configured to display an indicator on said display, said indicator indicating a most recently visited page.

25. A computer program product comprising software instructions that, when executed in a mobile communication terminal, performs the method of claim 1.
